(19) United States
(12) Patent Application Publication
(10) Pub. No.: US 2013/0260231 A1
(43) Pub. Date: Oct. 3, 2013

(54) LITHIUM-ION BATTERIES AND CATHODE MATERIALS THEREOF

(71) Applicants: Bin Hua, Ningde City (CN); Na Liu, Ningde City (CN); Rui Xu, Ningde City (CN)

(72) Inventors: Bin Hua, Ningde City (CN); Na Liu, Ningde City (CN); Rui Xu, Ningde City (CN)

(21) Appl. No.: 13/437,152

(22) Filed: Apr. 2, 2012

(51) Int. Cl. H01M 4/64; H01M 4/525

(52) U.S. Cl. 429/211; 252/182.1

(57) ABSTRACT

The invention provides a type of lithium-ion battery cathode materials applicable to a high charge cut-off voltage. The cathode materials comprises two active substances of LiCoO₂ and Li (NixCoyMn1-x-y)O₂, where 0.3≦x≦0.8, 0.1≦y≦0.4, and 0.6≦x+y≦0.9. Both LiCoO2 and Li(NixCoyMn1-x-y)O2 are doped with element M and then treated by surface coating with the oxide, sulfide, fluoride of element M′ or phosphate. The element M is at least one of the Mg, Ti, Al, Zr, B, La, Ce, Y, P, S, N or F while the element M′ is at least one of the Al, Ti, Mg, Zr, B, Si, Fe, La, Ce or Y. The cathode materials provided herein, having the advantages of excellent cycling performance and low cell swelling against high temperature, can help to remarkably increase the energy density of lithium-ion batteries. The invention also discloses a lithium-ion battery containing such cathode materials.

### TECHNICAL FIELD OF THE INVENTION

The present invention relates to the category of lithium-ion battery technology, more particularly to a type of lithium-ion battery cathode materials which are applicable to a high charge cut-off voltage. It also relates to a high energy density lithium-ion battery containing such cathode materials.

### BACKGROUND OF THE INVENTION

As lithium-ion batteries have the advantages of high energy density, excellent cycling performance, high working voltage and no memory effect, they have become one of the most widely used secondary batteries. Along with the soaring development of the electronic technology, people come up with more requirements on lithium-ion batteries with respect to higher energy density and better cycling durability. Therefore, it is essential for the development of lithium-ion batteries to develop cathode materials with high performance.

At present, as to commercially available lithium-ion battery cathode materials, the most widely used and maturely developed cathode material is LiCoO₂. Although the LiCoO₂ has a theoretic specific capacity per gram of 275 mAh/g, its reversible specific capacity per gram under 4.2 V working cut-off voltage (vs. Li/Li⁺) is relatively low, only about 140 mAh/g. However, if the charge cut-off voltage of the LiCoO₂ is raised higher than 4.2V, this will easily result in damaged structures, declined thermostability and poorer battery cycling performance. It imposes great safety hazards. Furthermore, the cobalt contained in the LiCoO₂ is of rare metals and thus provides limited availability with high costs, and meanwhile it is environmentally harmful. For these reasons, it is a development trend to develop cobalt free or low-cobalt cathode materials, which feature low costs, high energy density and excellent safety, for the lithium-ion battery cathode materials.

Recently, Li(NiₓCo_{y}Mn_{1-x-y})O₂ (0.3≦x≦0.8, 0.1≦y≦0.4) has witnessed a rapid development because of its low costs, excellent safety and a superior capacity (actually up to 180-190 mAh/g) beyond the LiCoO₂. Nevertheless, as the Li(NiₓCo_{y}Mn_{1-x-y})O₂ has low pressed density (merely 3.6 g/cm³) and low discharge voltage, it cannot meet actual needs. In addition, the high specific capacity per gram of the Li(NiₓCo_{y}Mn_{1-x-y})O₂ mainly comes from adding the nickel contents, which in turn results in lower material thermostability, decomposed electrolytes under high temperature, and enormous gases, consequently, severe potential safety hazards exist. Based on the above facts, solely the Li(NiₓCo_{y}Mn_{1-x-y})O₂ cannot meet the market needs for high performance cathode materials.

It is possible for the Li(NiₓCo_{y}Mn_{1-x-y})O₂ to be mixed with the LiCoO₂ to combine their respective advantages, so that lower material costs and improved electrochemical properties and safety are achieved. However, mechanically mixing these two materials together cannot obtain the satisfactory battery performance or to improve the storage performance under high temperature.

In consideration of the above problems, it is necessary to provide a type of lithium-ion battery cathode materials which are applicable to the high charge cut-off voltage so as to improve the electrochemical properties, safety and high-temperature storage performance of the high voltage lithium-ion batteries. Meanwhile, it is also necessary to provide a lithium-ion battery containing such cathode materials.

### SUMMARY OF THE INVENTION

In view of the abovementioned problems, it is one object of the invention to overcome the drawbacks of the prior art by providing a type of lithium-ion battery cathode materials which are applicable to a high charge cut-off voltage.

To achieve aforesaid object, the adopted technical solution is described below:

A type of lithium-ion battery cathode materials, in accordance with the present invention, comprise two active substances of LiCoO₂ and Li (NixCoyMn1-x-y) O₂, where 0.3≦x≦0.8, 0.1≦y≦0.4, and 0.6≦x+y≦0.9.

The LiCoO₂ is doped with element M and then treated by surface coating with the oxide, sulfide, fluoride of element M′ or phosphate, and the Li(NixCoyMn1-x-y)O₂ is also doped with element M and then treated by surface coating with the oxide, sulfide or fluoride of element M′ or by phosphate, in which the element M is at least one of the Mg, Ti, Al, Zr, B, La, Ce, Y, P, S, N or F while the element M′ is at least one of the Al, Ti, Mg, Zr, B, Si, Fe, La, Ce or Y.

In accordance with the XRD pattern of said cathode materials, the diffraction angle 2θ₁ of the crystal face (003) of the Li(NiₓCo_{y}Mn_{1-x-y})O₂ is 18.55°-18.85° while the diffraction angle 2θ₂ of the crystal face (003) of the LiCoO₂ is 18.85°-19.00°, having the difference Δθ₁ of 0.20°-0.30° therebetween. The diffraction angle 2θ₃ of the crystal face (104) of the Li(NiₓCo_{y}Mn_{1-x-y})O₂ is 44.30°-44.50° while the diffraction angle 2θ₄ of the crystal face (104) of the LiCoO₂ is 45.10°-45.30°, having the difference Δθ₂ of 0.65°-0.85° therebetween.

In accordance with the XRD pattern of said cathode materials, the ratio I₀₀₃/I₁₀₄ between the diffraction peak intensity I₀₀₃ for the crystal face (003) of the Li(NiₓCo_{y}Mn_{1-x-y})O₂ and the diffraction peak intensity I₁₀₄ for the crystal face (104) of the Li(NiₓCo_{y}Mn_{1-x-y})O₂ is 1.10-1.40; the ratio I₀₀₃/I₁₀₄ between the diffraction peak intensity I₀₀₃ for the crystal face (003) of the LiCoO₂ and the diffraction peak intensity I₁₀₄ for the crystal face (104) of the LiCoO₂ is 1.20-1.50.

Said cathode materials have a BET of 0.20-0.50 m²/g.

Said cathode materials have a charge cut-off voltage (vs. Li/Li⁺) for said cathode materials of 4.2 V-4.6 V.

The LiCoO₂ materials are electrochemically stable with excellent cycling performance and they have a desired compatibility with the electrolyte, but a specific capacity per gram is merely 140 mAh/g. Furthermore, they have the disadvantages of high costs and high likelihood of undergoing structure damages if the charge cut-off voltage is more than 4.2 V, thereby leading to poorer thermostability. As to the Li(NiₓCo_{y}Mn_{1-x-y})O₂ materials, they are low in costs and high in actual capacity of up to 180-190 mAh/g, however, their pressed density is low and the compatibility with the electrolyte under high temperature is poor. It is possible for the Li(NiₓO_{y}Mn_{1-x-y})O₂ materials to be mixed with the LiCoO2 materials to combine their respective advantages, so that lower material costs and improved electrochemical properties and safety are achieved. Besides, if a small amount of a certain element or its oxide, sulfide or fluoride, or phosphate is evenly added into the cathode materials or settles on the surface thereof, it can effectively improve the material structural stability and the side reaction of the electrolyte on the cathode material surface is avoided, thereby the high-temperature storage performance and safety of lithium-ion batteries are improved. At the same time, no obvious attenuation occurs to the material reversible capacity, which makes the cathode materials applicable to the high charge cut-off voltage and the battery energy density is remarkably improved.

As the cathode materials of the Li(NiₓO_{y}Mn_{1-x-y})O₂ are composed of varied transition metal elements, not all such transition metal elements can be evenly distributed in crystals depending on different synthetic processes and conditions. It places a serious impact on the electrochemical performance of the cathode materials. The diffraction peak of crystal face (003) represents the stacking degree of the layered structure within the cathode materials, the diffraction peak of crystal face (104) represents the distribution of the transition metal elements of the cathode materials within the layered structure, while the ratio I₀₀₃/I₁₀₄ between the diffraction peak intensity I₀₀₃ of the crystal face (003) and the diffraction peak intensity I₁₀₄ of the crystal face (104) represent that the transition metal elements of the cathode materials are evenly distributed within the active substance crystals. Therefore, both the locations of 2θ and the value of I₀₀₃/I₁₀₄ are restricted as described above so as to maintain the intact crystal structures and to keep the doped elements and the coated materials on the surface even. Consequently, sufficient reactivity is achieved in the active cathode materials, excellent electrochemical properties and cycling performance are obtained and the battery's expansion against high temperature and cycling swelling are reduced.

The compound cathode materials provided herein have the BET of 0.20-0.50 m²/g. If the superficial area is too large, the electrolyte will react more violently on the surface of the cathode materials, so that battery electrochemical properties become deteriorated. On the contrary, too small superficial area will result in large partical size to affect the dynamic behavior of the lithium-ion during the reversible insertion/extraction process.

As an improvement to the lithium-ion battery cathode materials provided by the present invention, in the Li(NiₓCo_{y}Mn_{1-x-y})O₂, 0.3≦x≦0.5, 0.2≦y≦0.35 and 0.65≦x+y≦0.7, so that the cathode materials with stable structure and high capacity can be obtained.

As an improvement to the lithium-ion battery cathode materials provided by the present invention, the mass percent that the LiCoO₂ in said cathode materials is 40%-80%, more preferably 50%-60%. In this way, the capacity, electrochemical properties and structural stability are ensured.

As an improvement to the lithium-ion battery cathode materials provided by the present invention, the mass percent of the doped element M in the whole materials is 0.02-0.6% while the mass percent of the oxide, sulfide or fluoride of the coating element M′ or phosphate in the whole materials is 0.05-1%. In this way, the structural stability and excellent electrochemical properties under the higher voltage (more than 4.2 V) are ensured, and no obvious attenuation occurs to the reversible capacity of the materials.

As an improvement to the lithium-ion battery cathode materials provided by the present invention, said 2θ₁ is 18.65°-18.75°, 2θ₂ is 18.90°-18.95° and Δθ₁ is 0.23°-0.27°; 2θ₃ is 44.40°-44.45°, 2θ₄ is 45.20°-45.25° and Δθ₂ is 0.70°-0.82°.

As an improvement to the lithium-ion battery cathode materials provided by the present invention, the ratio I₀₀₃/I₁₀₄ between the diffraction peak intensity I₀₀₃ for the crystal face (003) of said Li(NiₓCo_{y}Mn_{1-x-y})O₂ and the diffraction peak intensity I₁₀₄ for the crystal face (104) of said Li(NiₓCo_{y}Mn_{1-x-y})O₂ is 1.25-1.35. The ratio I₀₀₃/I₁₀₄ between the diffraction peak intensity I₀₀₃ for the crystal face (003) of said LiCoO₂ and the diffraction peak intensity I₁₀₄ for the crystal face (104) of said LiCoO₂ is 1.35-1.45.

As an improvement to the lithium-ion battery cathode materials provided by the present invention, said cathode materials have the BET of 0.24-0.40 m²/g and the charge cut-off voltage (vs. Li/Li⁺) of 4.3 V-4.5 V.

As an improvement to the lithium-ion battery cathode materials provided by the present invention, said cathode materials have the pressed density of more than or equal to 3.95 g/cm³ and an initial reversible capacity of more than or equal to 155 mAh/g under the 4.3 V cut-off voltage (vs. Li/Li⁺) and they have the initial reversible capacity of more than or equal to 170 mAh/g under the 4.4 V cut-off voltage (vs. Li/Li⁺).

Furthermore, the cathode materials provided herein is optionally treated by secondary coating with the oxide, sulfide or fluoride of element M″ or the phosphate, where the element M″ is at least one of the Al, Ti, Mg, Zr, B, Si or Fe. Consequently, the electrochemical properties of the cathode materials under a high charge cut-off voltage are further improved.

In comparison with the prior art, appropriate Li(NiₓO_{y}Mn_{1-x-y})O₂ materials are adopted to mix with the LiCoO₂ cathode materials and then treated by coating process as described herein, during which each technological parameter is under strict control, as a result, the obtained compound materials have a remarkably improved stability and are applicable to a high charge cut-off voltage. When the cathode materials provided herein are adopted, lithium-ion batteries have its energy density hugely improved and obtain the advantages such as excellent cycling performance and low cell swelling against high temperature.

A lithium-ion battery, in accordance with the present invention, comprises an anode sheet, a cathode sheet and a separator therebetween as well as an electrolyte, in which said cathode sheet includes a cathode current collector and active cathode substance layers which are coated on said cathode current collector. The cathode substance layers are composed of active cathode substances, adhesives and conductive agent, wherein said active cathode substances are the lithium-ion battery cathode materials as described above.

In comparison with the prior art, the lithium-ion battery, containing the cathode materials provided by the present invention, has the advantages of high energy density, excellent cycling performance and low cell swelling against high temperature, therefore, it can be applied in high voltage systems.

### BRIEF DESCRIPTION OF THE DRAWINGS

FIG. 1 is a XRD curve of cathode materials in accordance with example 1 of the present invention;

FIG. 2 is a SEM profile of the cathode materials in accordance with example 1 of the present invention;

FIG. 3 is an initial reversible capacity curve of the cathode materials within the button battery under varied voltages in accordance with example 1 and comparative example 1 of the present invention;

FIG. 4 is a cycling test curve of the battery under a voltage of 3.0-4.3V in accordance with example 1 and comparative example 1 of the present invention;

FIG. 5 is a 60° C./30d storage curve of the battery under a voltage of 4.3V in accordance with example 1 and comparative example 1 of the present invention; and

FIG. 6 is a 60° C./30d storage curve of the battery under a voltage of 4.35V in accordance with example 1 and comparative example 1 of the present invention.

### DETAILED DESCRIPTION OF THE EMBODIMENTS

The present invention is explained in further detail below with reference to the attached drawings. It should be noted that descriptions of the embodiments below of the invention are intended to illustrate but not to limit this invention.

In the test, CR 2430 coin cell and 454261 polymer lithium-ion batteries are used to study the electrochemical properties of the cathode materials provided by the present invention.

For the cathode, NMP is adopted as a solvent to prepare a 70% (solid content) of sizing agents that are evenly coated on Al foils based on the mass percent of the active substances:SP:PVDF=95:2:3.

For the anode, deionized water is adopted as a solvent to prepare a 45% (solid content) of sizing agents that are evenly coated on Cu foils based on the mass percent of the graphite:SP:SBR:CMC=94:2:2:2.

The electrolyte is a LiPF₆ solution (1 mol/L) and the solvent is a mixture with EC, DEC and EMC based on their volume ratio of 1:1:1.

The anode of the coin cell is made of lithium sheets while the cathode is the cathode sheets provided herein. In an argon protected glove-box, the anode, cathode, electrolyte, separator and steel shell are assembled into the coin cell. The test cycling rate for charge/discharge is 0.1 C/0.05 C, the charge cut-off voltage (vs. Li/Li⁺) is 4.2 V-4.4V and the discharge cut-off voltage (vs. Li/Li⁺) is 3.0 V.

The obtained anode, cathode and separator are winded to form a battery core and then 454261 polymer batteries are completed following a plurality of major processes such as casing, top sealing, electrolyte injection, formation and inspection. The test cycling rate for charge/discharge is 0.5 C/0.5 C, the test temperature is 45° C., the charge cut-off voltage is 4.2 V-4.4V and the discharge cut-off voltage is 3.0V. The 85° C./4 h high temperature storage test for batteries is carried as follows: firstly, batteries are charged by 05 C constant current followed by constant voltage to 0.05 C under the room temperature until the corresponding voltage reaches to 4.2V-4.4V; secondly, the batteries are left to stand for 1 hours before the battery thickness, voltage and internal resistance are measured; thirdly, the batteries are placed into a 85° C. calorstat and left to stand for 4 hours and then battery thickness, voltage and internal resistance are measured under a high temperature. The 60° C./30d high temperature storage test for batteries is carried as follows: firstly, batteries are charged by 0.5 C constant current followed by constant voltage to 0.05 C under the room temperature until the corresponding voltage reaches to 4.2V-4.4V; secondly, the batteries are left to stand for 1 hour before the battery thickness, voltage and internal resistance are measured; thirdly, the batteries are placed into a 60° C. calorstat and then battery thickness, voltage and internal resistance are measured once under high temperature for every 3 days when they are left to stand under a constant temperature until the storage period expires.

HT storage cell swelling ratio=(thickness after storage−thickness before storage)/thickness before storage×100%

### Example 1

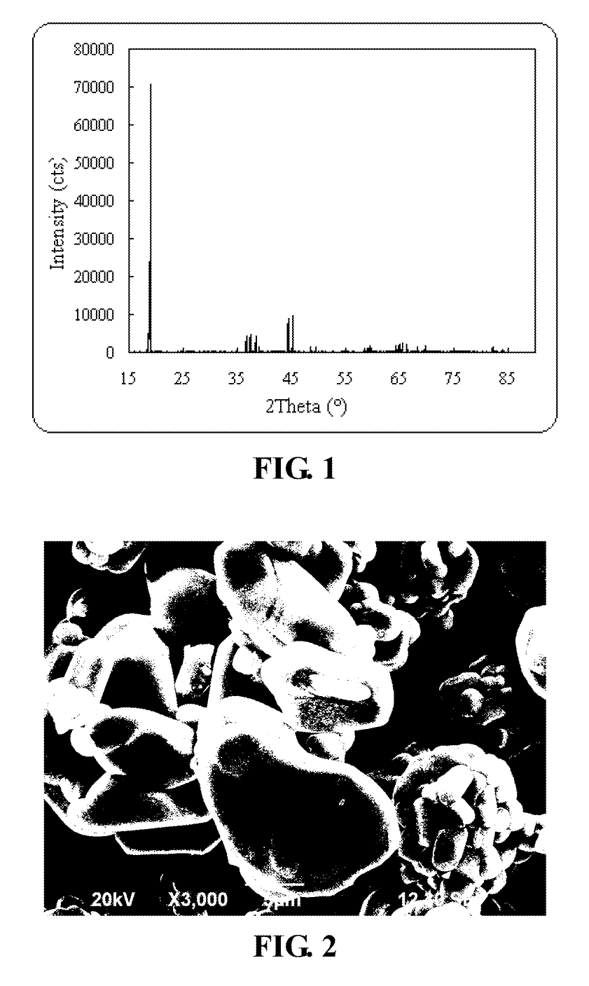

The active cathode substances used in this example are compound cathode materials, mixed with LiCoO₂ and Li(Ni_{0.5} Co_{0.2}Mn_{0.3})O₂, wherein the LiCoO₂ accounts for 60% by mass, the BET is 0.38 m²/g, the contents of the doped and/or coating elements Mg, Al, Ti and La are 0.11%, 0.08%, 0.15%, and 0.01%. As shown in the XRD pattern, 2θ₁, 2θ₂, Δθ₁, 2θ₃, 2θ₄ and Δθ₂ are 18.69°, 18.93°, 0.24°, 44.40°, 45.22° and 0.82°. I₀₀₃/I₁₀₄ of the Li(Ni_{0.5} Co_{0.2}Mn_{0.3})O₂ and the LiCoO₂ are 1.28 and 1.45 respectively. The pressed density of the cathode made of such active substances is 4.0 g/cm³. The XRD pattern and SEM profile of said cathode compounds are separately shown in FIG. 1 and FIG. 2.

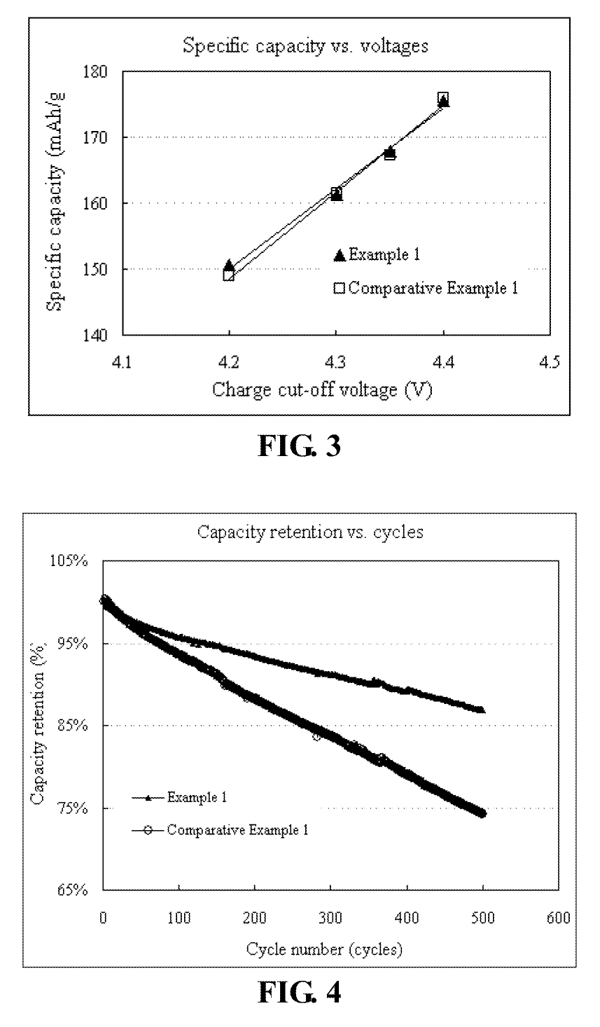

In the test for coin cell, the initial reversible capacities of said compound cathode materials under the cut-off voltages of 4.3V and 4.4V are 161.3 mAh/g and 175.5 mAh/g, respectively. The initial reversible capacities of said cathode compounds under varied voltages are shown in FIG. 3.

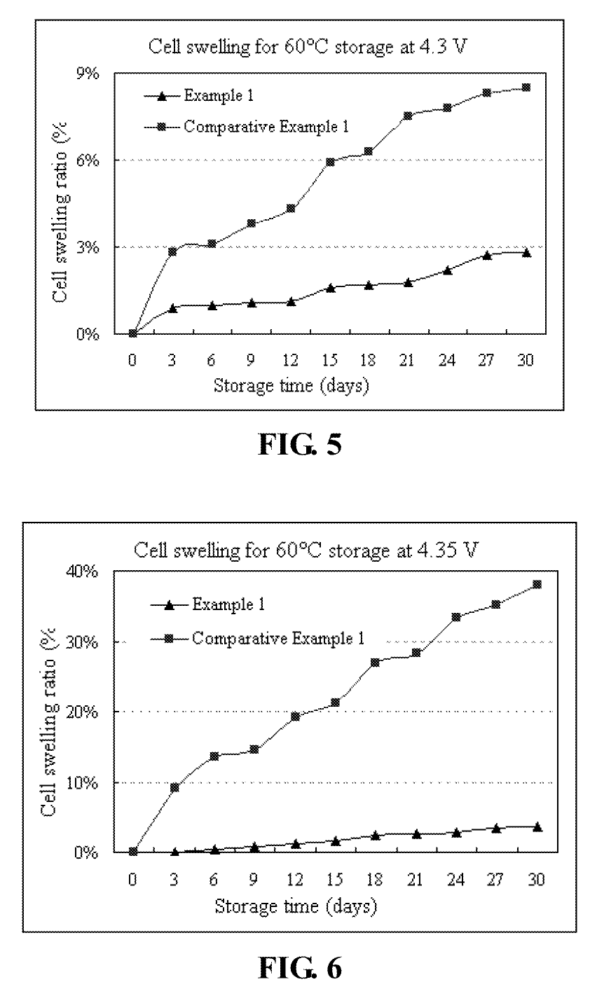

If said cathode materials are applied in 454261 polymer batteries, they have a capacity retention rate of 87% after 500 cycles under the voltage of 3.0-4.3V as shown in the cycling curve in FIG. 4. As to the 85° C./4 h high temperature storage, the cell swelling ratios under the voltages of 4.3V and 4.35V are 13% and 45%, respectively. As to the 60° C./30d high temperature storage, the cell swelling ratio under the voltage of 4.3V is 3%. FIG. 5 is a trend curve of cell swelling changing along with the storage time. As to the 60° C./30d high temperature storage, the cell swelling ratio under the voltage of 4.35V is 4%. FIG. 6 is a trend curve of cell swelling changing along with the storage time.

### Example 2

The active cathode substances used in this example are compound cathode materials, mixed with LiCoO₂ and Li(Ni_{0.5} Co_{0.2}Mn_{0.3})O₂, wherein the LiCoO₂ accounts for 70% by mass, the BET is 0.40 m²/g, the contents of the doped and/or coating elements Mg, Al, Ti and Y are 0.25%, 0.05%, 0.08%, and 0.01%. As shown in the XRD pattern, 2θ₁, 2θ₂, Δθ₁, 2θ₃, 2θ₄ and Δθ₂ are 18.65°, 18.90°, 0.25°, 44.40°, 45.20° and 0.80°. I₀₀₃/I₁₀₄ of the Li(Ni_{0.5} Co_{0.2}Mn_{0.3})O₂ and the LiCoO₂ are 1.31 and 1.42, respectively. The pressed density of the cathode made of such active substances is 4.0 g/cm³.

In the test for coin cell, the initial reversible capacities of said compound cathode materials under the cut-off voltages of 4.3V and 4.4V are 159.8 mAh/g and 173.0 mAh/g, respectively.

If said cathode materials are applied in 454261 polymer batteries, they have capacity retention rates of 85% and 81% after 500 cycles under the voltages of 3.0-4.3V and 3.0-4.35V, respectively. As to the 85° C./4 h high temperature storage, the cell swelling ratios under the voltages of 4.3V and 4.35V are 80% and 125%, respectively. As to the 60° C./30d high temperature storage, the cell swelling ratios under the voltages of 4.3V and 4.35V are 4% and 8%, respectively.

### Example 3

The active cathode substances used in this example are compound cathode materials, mixed with LiCoO₂ and Li(Ni_{0.5} Co_{0.2}Mn_{0.3})O₂, wherein the LiCoO₂ accounts for 80% by mass, the BET is 0.28 m²/g, the contents of the doped and/or coating elements Mg, Al, Ti and Y are 0.30%, 0.08%, 0.06%, and 0.01%. As shown in the XRD pattern, 2θ₁, 2θ₂, Δθ₁, 2θ₃, 2θ₄ and Δθ₂ are 18.71°, 18.94°, 0.23°, 44.42°, 45.23° and 0.81°. I₀₀₃/I₁₀₄ of the Li(Ni_{0.5} Co_{0.2}Mn_{0.3})O₂ and the LiCoO₂ are 1.35 and 1.44, respectively. The pressed density of the cathode made of such active substances is 4.0 g/cm³.

In the test for coin cell, the initial reversible capacities of said compound cathode material under the cut-off voltages of 4.3V and 4.4V are 158.1 mAh/g and 172.4 mAh/g, respectively.

If said cathode materials are applied in 454261 polymer batteries, they have a capacity retention rate of 84% after 500 cycles under the voltage of 3.0-4.3V. As to the 85° C./4 h high temperature storage, the cell swelling ratio under the voltage of 4.3V is 120%. As to the 60° C./30d high temperature storage, the cell swelling ratio under the voltage of 4.3V is 10%.

### Example 4

The active cathode substances used in this example are compound cathode materials, mixed with LiCoO₂ and Li(Ni_{0.5} Co_{0.2}Mn_{0.3})O₂, wherein the LiCoO₂ accounts for 50% by mass, the BET is 0.35 m²/g, the contents of the doped and/or coating elements Mg, Al, Ti and La are 0.05%, 0.20%, 0.10%, and 0.01%. As shown in the XRD pattern, 2θ₁, 2θ₂, Δθ₁, 2θ₃, 2θ₄ and Δθ₂ are 18.55°, 18.85°,0.30°, 44.65°,45.30° and 0.65°. I₀₀₃/I₁₀₄ of the Li(Ni_{0.5} Co_{0.2}Mn_{0.3})O₂ and the LiCoO₂ are 1.10 and 1.20, respectively. The pressed density of the cathode made of such active substances is 4.0 g/cm³.

In the test for coin cell, the initial reversible capacities of said cathode compounds under the cut-off voltages of 4.3V and 4.4V are 159.2 mAh/g and 174.6 mAh/g, respectively.

If said cathode materials are applied in 454261 polymer batteries, they have a capacity retention rate of 83% after 500 cycles under the voltage of 3.0-4.3V. As to the 85° C./4 h high temperature storage, the cell swelling ratio under the voltage of 4.3V is 130%. As to the 60° C./30d high temperature storage, the cell swelling ratio under the voltage of 4.3V is 25%.

### Example 5

The active cathode substances used in this example are compound cathode materials, mixed with LiCoO₂ and Li(Ni_{0.5} Co_{0.2}Mn_{0.3})O₂, wherein the LiCoO₂ accounts for 40% by mass, the BET is 0.27 m²/g, the contents of the doped and/or coating elements Mg, Al, Ti and Zr are 0.05%, 0.15%, 0.08%, and 0.22%. As shown in the XRD pattern, 2θ₁, 2θ₂, Δθ₁, 2θ₃, 2θ₄ and Δθ₂ are 18.80°, 19.00°, 0.20°, 44.35°, 45.20° and 0.85°. I₀₀₃/I₁₀₄ of the Li(Ni_{0.5} Co_{0.2}Mn_{0.3})O₂ and the LiCoO₂ are 1.25 and 1.35, respectively. The pressed density of the cathode made of such active substances is 4.1 g/cm³.

In the test for coin cell, the initial reversible capacities of said cathode compounds under the cut-off voltages of 4.3V and 4.4V are 159.8 mAh/g and 173.8 mAh/g, respectively.

If said cathode materials are applied in 454261 polymer batteries, they have a capacity retention rate of 85% after 500 cycles under the voltage of 3.0-4.3V. As to the 85° C./4 h high temperature storage, the cell swelling ratio under the voltage of 4.3V is 45%. As to the 60° C./30d high temperature storage, the cell swelling ratio under the voltage of 4.3V is 7%.

### Example 6

The active cathode substances used in this example are compound cathode materials, mixed with LiCoO₂ and Li(Ni_{0.5} Co_{0.2}Mn_{0.3})O₂, wherein the LiCoO₂ accounts for 45% by mass, the BET is 0.21 m²/g, the contents of the doped and/or coating elements Mg, Al and Ti are 0.05%, 0.22%, and 0.15%. As shown in the XRD pattern, 2θ₁, 2θ₂, Δθ₁, 2θ₃, 2θ₄ and Δθ₂ are 18.72°, 18.92°, 0.20°, 44.41°, 45.23° and 0.82°. I₀₀₃/I₁₀₄ of the Li(Ni_{0.5} Co_{0.2}Mn_{0.3})O₂ and the LiCoO₂ are 1.38 and 1.45, respectively. The pressed density of the cathode made of such active substances is 4.05 g/cm³.

In the test for coin cell, the initial reversible capacities of said cathode compounds under the cut-off voltages of 4.3V and 4.4V are 155.6 mAh/g and 170.5 mAh/g, respectively.

If said cathode materials are applied in 454261 polymer batteries, they have a capacity retention rate of 82% after 500 cycles under the voltage of 3.0-4.3V. As to the 85° C./4 h high temperature storage, the cell swelling ratio under the voltage of 4.3V is 63%. As to the 60° C./30d high temperature storage, the cell swelling ratio under the voltage of 4.3V is 9%.

### Example 7

The active cathode substances used in this example are compound cathode materials, mixed with LiCoO₂ and Li(Ni_{0.5} Co_{0.2}Mn_{0.3})O₂, wherein the LiCoO₂ accounts for 50% by mass, the BET is 0.29 m²/g, the contents of the doped and/or coating elements Mg, Ti and La are 0.08%, 0.15%, and 0.01%. As shown in the XRD pattern, 2θ₁, 2θ₂, Δθ₁, 2θ₃, 2θ₄ and Δθ₂ are 18.67°, 18.92°, 0.25°, 44.44°, 45.22° and 0.78°. I₀₀₃/I₁₀₄ of the Li(Ni_{0.5} Co_{0.2}Mn_{0.3})O₂ and the LiCoO₂ are 1.25 and 1.38, respectively. The pressed density of the cathode made of such active substances is 4.0 g/cm³.

In the test for coin cell, the initial reversible capacities of said cathode compounds under the cut-off voltages of 4.3V and 4.4V are 164.6 mAh/g and 176.1 mAh/g, respectively.

If said cathode materials are applied in 454261 polymer batteries, they have a capacity retention rate of 77% after 500 cycles under the voltage of 3.0-4.3V. As to the 85° C./4 h high temperature storage, the cell swelling ratio under the voltage of 4.3V is 130%. As to the 60° C./30d high temperature storage, the cell swelling ratio under the voltage of 4.3V is 18%.

### Example 8

The active cathode substances used in this example are compound cathode materials, mixed with LiCoO₂ and Li(Ni_{0.5} Co_{0.2}Mn_{0.3})O₂, wherein the LiCoO₂ accounts for 65% by mass, the BET is 0.31 m²/g, the contents of the doped and/or coating elements Mg, Al, Ti and La are 1%, 0.08%, 0.15%, and 0.01%. As shown in the XRD pattern, 2θ₁, 2θ₂, Δθ₁, 2θ₃, 2θ₄ and Δθ₂ are 18.69°, 18.95°, 0.26°, 44.42°, 45.23° and 0.81°. I₀₀₃/I₁₀₄ of the Li(Ni_{0.5} Co_{0.2}Mn_{0.3})O₂ and LiCoO₂ are 1.40 and 1.50, respectively. The pressed density of the cathode made of such active substances is 4.1 g/cm³.

In the test for coin cell, the initial reversible capacities of said cathode compounds under the cut-off voltages of 4.3V and 4.4V are 162.5 mAh/g and 173.4 mAh/g, respectively.

If said cathode materials are applied in 454261 polymer batteries, they have a capacity retention rate of 78% after 500 cycles under the voltage of 3.0-4.3V. As to the 85° C./4 h high temperature storage, the cell swelling ratio under the voltage of 4.3V is 110%. As to the 60° C./30d high temperature storage, the cell swelling ratio under the voltage of 4.3V is 10%.

### Example 9

The active cathode substances used in this example are compound cathode materials, mixed with LiCoO₂ and Li(Ni_{0.5} Co_{0.2}Mn_{0.3})O₂, wherein the LiCoO₂ accounts for 75% by mass, the BET is 0.50 m²/g, the contents of the doped and/or coating elements Mg, Al and Y are 0.05%, 0.01%, and 0.01%. As shown in the XRD pattern, 2θₖ, 2θ₂, Δθ₁, 2θ₃, 2θ₄ and Δθ₂ are 18.70°, 18.94°, 0.24°, 44.42°, 45.23° and 0.81°. I₀₀₃/I₁₀₄ of the Li(Ni_{0.5} Co_{0.2}Mn_{0.3})O₂ and LiCoO₂ are 1.38 and 1.48, respectively. The pressed density of the cathode made of such active substances is 4.1 g/cm³.

In the test for coin cell, the initial reversible capacities of said cathode compounds under the cut-off voltages of 4.3V and 4.4V are 159.8 mAh/g and 171.6 mAh/g, respectively.

If said cathode materials are applied in 454261 polymer batteries, they have a capacity retention rate of 83% after 500 cycles under the voltage of 3.0-4.3V. As to the 85° C./4 h high temperature storage, the cell swelling ratio under the voltage of 4.3V is 90%. As to the 60° C./30d high temperature storage, the cell swelling ratio under the voltage of 4.3V is 8%.

### Example 10

The active cathode substances used in this example are compound cathode materials, mixed with LiCoO₂ and Li(Ni_{0.5} Co_{0.2}Mn_{0.3})O₂, wherein the LiCoO₂ accounts for 55% by mass, the BET is 0.36 m²/g, the contents of the doped and/or coating elements Mg, Al, Ti and La are 0.06%, 0.15%, 0.05%, and 0.01%. As shown in the XRD pattern, 2θₖ, 2θ₂, Δθ₁, 2θ₃, 2θ₄ and Δθ₂ are 18.56°, 18.83°, 0.27°, 44.50°, 45.23° and 0.73°. I₀₀₃/I₁₀₄ of the Li(Ni_{0.5} Co_{0.2}Mn_{0.3})O₂ and LiCoO₂ are 1.40 and 1.50, respectively. The pressed density of the cathode made of such active substances is 4.0 g/cm³.

In the test for coin cell, the initial reversible capacities of said cathode compounds under the cut-off voltages of 4.3V and 4.4V are 159.3 mAh/g and 171.4 mAh/g, respectively.

If said cathode materials are applied in 454261 polymer batteries, they have a capacity retention rate of 83% after 500 cycles under the voltage of 3.0-4.3V. As to the 85° C./4 h high temperature storage, the cell swelling ratios under the voltages of 4.3V and 4.35V are 67% and 88%, respectively. As to the 60° C./30d high temperature storage, the cell swelling ratios under the voltages of 4.3V and 4.35V are 6% and 16%, respectively.

### Example 11

The active cathode substances used in this example are compound cathode materials, mixed with LiCoO₂ and Li(Ni_{0.5} Co_{0.2}Mn_{0.3})O₂, wherein the LiCoO₂ accounts for 60% by mass, the BET is 0.47 m²/g, the contents of the doped and/or coating elements Mg, Al, Ti and La are 0.05%, 0.30%, 0.08%, and 0.01%. As shown in the XRD pattern, 2θₖ, 2θ₂, Δθ₁, 2θ₃, 2θ₄ and Δθ₂ are 18.55°, 18.85°, 0.30°, 44.48°, 45.22° and 0.74°. I₀₀₃/I₁₀₄ of the Li(Ni_{0.5} Co_{0.2}Mn_{0.3})O₂ and the LiCoO₂ are 1.32 and 1.41, respectively. The pressed density of the cathode made of such active substances is 4.0 g/cm³.

In the test for coin cell, the initial reversible capacities of said cathode compounds under the cut-off voltages of 4.3V and 4.4V are 159.0 mAh/g and 170.8 mAh/g, respectively.

If said cathode materials are applied in 454261 polymer batteries, they have capacity retention rates of 85% and 82% after 500 cycles under the voltages of 3.0-4.3V and 3.0-4.35V respectively. As to the 85° C./4 h high temperature storage, the cell swelling ratios under the voltages of 4.3V and 4.35V are 55% and 77%, respectively. As to the 60° C./30d high temperature storage, the cell swelling ratios under the voltages of 4.3V and 4.35V are 3% and 6%, respectively.

### Example 12

The active cathode substances used in this example are compound cathode materials, mixed with LiCoO₂ and Li(Ni_{0.5} Co_{0.2}Mn_{0.3})O₂, wherein the LiCoO₂ accounts for 60% by mass, the BET is 0.41 m²/g, the contents of the doped and/or coating elements Mg, Al, Ti and Y are 0.08%, 0.15%, 0.08%, and 0.01%. As shown in the XRD pattern, 2θ₁, 2θ₂, Δθ₁, 2θ₃, 2θ₄ and Δθ₂ are 18.58°, 18.87°, 0.29°, 44.38°, 45.23° and 0.85°. I₀₀₃/I₁₀₄ of the Li(Ni_{0.5} Co_{0.2}Mn_{0.3})O₂ and the LiCoO₂ are 1.35 and 1.44, respectively. The pressed density of the cathode made of such active substances is 4.0 g/cm³.

In the test for coin cell, the initial reversible capacities of said cathode compounds under the cut-off voltages of 4.3V and 4.4V are 160.3 mAh/g and 171.9 mAh/g, respectively.

If said cathode materials are applied in 454261 polymer batteries, they have capacity retention rates of 82% and 77% after 500 cycles under the voltages of 3.0-4.3V and 3.0-4.35V, respectively. As to the 85° C./4 h high temperature storage, the cell swelling ratios under the voltages of 4.3V and 4.35V are 71% and 91%, respectively. As to the 60° C./30d high temperature storage, the cell swelling ratios under the voltages of 4.3V and 4.35V are 4% and 12%, respectively.

### Example 13

The active cathode substances used in this example are compound cathode materials, mixed with LiCoO₂ and Li(Ni_{0.5} Co_{0.2}Mn_{0.3})O₂, wherein the LiCoO₂ accounts for 50% by mass, the BET is 0.50 m²/g, the contents of the doped and/or coating elements Mg, Al, Zr and Y are 0.06%, 0.32%, 0.10%, and 0.01%. As shown in the XRD pattern, 2θ₁, 2θ₂, Δθ₁, 2θ₃, 2θ₄ and Δθ₂ are 18.62°, 18.87°, 0.25°, 44.40°, 45.20° and 0.80°. I₀₀₃/I₁₀₄ of the Li(Ni_{0.5} Co_{0.2}Mn_{0.3})O₂ and the LiCoO₂ are 1.28 and 1.38, respectively. The pressed density of the cathode made of such active substances is 4.0 g/cm³.

In the test for coin cell, the initial reversible capacities of said cathode compounds under the cut-off voltages of 4.3V and 4.4V are 158.9 mAh/g and 170.5 mAh/g, respectively.

If said cathode materials are applied in 454261 polymer batteries, they have capacity retention rates of 83% and 81% after 500 cycles under the voltages of 3.0-4.3V and 3.0-4.35V, respectively. As to the 85° C./4 h high temperature storage, the cell swelling ratios under the voltages of 4.3V and 4.35V are 79% and 112%, respectively. As to the 60° C./30d high temperature storage, the cell swelling ratios under the voltages of 4.3V and 4.35V are 8% and 21%, respectively.

### Example 14

The active cathode substances used in this example are compound cathode materials, mixed with LiCoO₂ and Li(Ni_{0.5} Co₀₂Mn₀₃)O₂, wherein the LiCoO₂ accounts for 60% by mass, the BET is 0.41 m²/g, the contents of the doped and/or coating elements Mg, Al, Ti and La are 0.15%, 0.12%, 0.25%, and 0.01%. As shown in the XRD pattern, 2θₖ, 2θ₂, Δθ₁, 2θ₃, 2θ₄ and Δθ₂ are 18.67°, 18.95°, 0.28°, 44.42°, 45.23° and 0.81°. I₀₀₃/I₁₀₄ of the Li(Ni_{0.5} Co_{0.2}Mn_{0.3})O₂ and LiCoO₂ are 1.21 and 1.50, respectively. The pressed density of the cathode made of such active substances is 4.0 g/cm³.

In the test for coin cell, the initial reversible capacities of said cathode compounds under the cut-off voltages of 4.3V and 4.4V are 169.6 mAh/g and 181.2 mAh/g, respectively.

If said cathode materials are applied in 454261 polymer batteries, they have a capacity retention rate of 71% after 500 cycles under the voltage of 3.0-4.3V. As to the 85° C./4 h high temperature storage, the cell swelling ratio under the voltage of 4.3V is 165%. As to the 60° C./30d high temperature storage, the cell swelling ratio under the voltage of 4.3V is 28%.

### Example 15

The active cathode substances used in this example are compound cathode materials, mixed with LiCoO₂ and Li(Ni_{0.5} Co_{0.2}Mn_{0.3})O₂, wherein the LiCoO₂ accounts for 60% by mass, the BET is 0.31 m²/g, the contents of the doped and/or coating elements Mg, Al, Ti and F are 1.5%, 3.0%, 0.8%, and 0.03%. As shown in the XRD pattern, 2θ₁, 2θ₂, Δθ₁, 2θ₃, 2θ₄ and Δθ₂ are 18.69°, 18.93°, 0.24°, 44.42°, 45.22° and 0.8°. I₀₀₃/I₁₀₄ of the Li(Ni_{0.5} Co_{0.2}Mn_{0.3})O₂ and the LiCoO₂ are 1.34 and 1.43, respectively. The pressed density of the cathode made of such active substances is 4.0 g/cm³.

In the test for coin cell, the initial reversible capacities of said cathode compounds under the cut-off voltages of 4.3V and 4.4V are 161.8 mAh/g and 171.9 mAh/g, respectively.

If said cathode materials are applied in 454261 polymer batteries, they have a capacity retention rate of 85% after 500 cycles under the voltage of 3.0-4.3V. As to the 85° C./4 h high temperature storage, the cell swelling ratio under the voltage of 4.3V is 35%. As to the 60° C./30d high temperature storage, the cell swelling ratio under the voltage of 4.3V is 7%.

### Example 16

The active cathode substances used in this example are compound cathode materials, mixed with LiCoO₂ and Li(Ni_{0.5} Co_{0.2}Mn_{0.3})O₂, wherein the LiCoO₂ accounts for 60% by mass, the BET is 0.35 m²/g, the contents of the doped and/or coating elements Mg, Al, Ti and S are 1.5%, 2.0%, 0.6%, and 0.03%. As shown in the XRD pattern, 2θₖ, 2θ₂, Δθ₁, 2θ₃, 2θ₄ and Δθ₂ are 18.68°, 18.93°, 0.25°, 44.43°, 45.23° and 0.8°. I₀₀₃/I₁₀₄ of the Li(Ni_{0.5} Co_{0.2}Mn_{0.3})O₂ and the LiCoO₂ are 1.31 and 1.42, respectively. The pressed density of the cathode made of such active substances is 4.0 g/cm³.

In the test for coin cell, the initial reversible capacities of said cathode compounds under the cut-off voltages of 4.3V and 4.4V are 161.5 mAh/g and 171.4 mAh/g, respectively.

If said cathode materials are applied in 454261 polymer batteries, they have a capacity retention rate of 82% after 500 cycles under the voltage of 3.0-4.3V. As to the 85° C./4 h high temperature storage, the cell swelling ratio under the voltage of 4.3V is 65%. As to the 60° C./30d high temperature storage, the cell swelling ratio under the voltage of 4.3V is 12%.

### Example 17

The active cathode substances used in this example are compound cathode materials, mixed with LiCoO₂ and Li(Ni_{0.5} Co_{0.2}Mn_{0.3})O₂, wherein the LiCoO₂ accounts for 60% by mass, the BET is 0.33 m²/g, the contents of the doped and/or coating elements Mg, Al, Ti and P are 1.5%, 2.0%, 0.8%, and 0.04%. As shown in the XRD pattern, 2θ₁, 2θ₂, Δθ₁, 2θ₃, 2θ₄ and Δθ₂ are 18.70°, 18.95°, 0.25°, 44.40°, 45.22° and 0.82°. I₀₀₃/I₁₀₄ of the Li(Ni_{0.5} Co_{0.2}Mn_{0.3})O₂ and the LiCoO₂ are 1.35 and 1.44, respectively. The pressed density of the cathode made of such active substances is 4.0 g/cm³.

In the test for coin cell, the initial reversible capacities of said cathode compounds under the cut-off voltages of 4.3V and 4.4V are 162.1 mAh/g and 172.6 mAh/g, respectively.

If said cathode materials are applied in 454261 polymer batteries, they have a capacity retention rate of 81% after 500 cycles under the voltage of 3.0-4.3V. As to the 85° C./4 h high temperature storage, the cell swelling ratio under the voltage of 4.3V is 80%. As to the 60° C./30d high temperature storage, the cell swelling ratio under the voltage of 4.3V is 9%.

### Comparative Example 1

The active cathode substances used in this comparative example are compound cathode materials, mixed with LiCoO₂ and Li(Ni_{0.5} Co_{0.2}Mn_{0.3})O₂, wherein the LiCoO₂ accounts for 60% by mass, the BET is 0.31 m²/g, the contents of the doped and/or coating elements Mg and Ti are 0.12% and 0.08%, respectively. As shown in the XRD pattern, 2θ₁, 2θ₂, Δθ₁, 2θ₃, 2θ₄ and Δθ₂ are 18.66°, 18.91°, 0.25°, 44.41°, 45.21° and 0.80°. I₀₀₃/I₁₀₄ of the Li(Ni_{0.5} Co_{0.2}Mn_{0.3})O₂ and the LiCoO₂ are 1.25 and 1.35, respectively. The pressed density of the cathode made of such active substances is 4.0 g/cm³.

In the test for coin cell, the initial reversible capacities of said cathode compounds under the cut-off voltages of 4.3V and 4.4V are 161.5 mAh/g and 175.9 mAh/g, respectively. The initial reversible capacities of said cathode compounds under varied voltages are shown in FIG. 3.

If said cathode materials are applied in 454261 polymer batteries, they have a capacity retention rate of 74% after 500 cycles under the voltage of 3.0-4.3V as shown in the cycling curve of FIG. 4; while the capacity retention rate is 68% after 500 cycles under the voltage of 3.0-4.35V. As to the 85° C./4 h high temperature storage, the cell swelling ratios under voltages of 4.3V and 4.35V are 83% and 125%, respectively. As to the 60° C./30d high temperature storage, the cell swelling ratio under the voltage of 4.3V is 9%. FIG. 5 is a trend curve of cell swelling changing along with the storage time. As to the 60° C./30d high temperature storage, the cell swelling ratio under the voltage of 4.35V is 38%. FIG. 6 is a variation trend curve of the cell swelling along with the storage time.

### Comparative Example 2

The active cathode substances used in this comparative example are compound cathode materials, mixed with LiCoO₂ and Li(Ni_{0.5} Co_{0.2}Mn_{0.3})O₂, wherein the LiCoO₂ accounts for 60% by mass, the BET is 0.28 m²/g, the contents of the doped and/or coating elements Mg and Ti are 0.05% and 0.10%, respectively. As shown in the XRD pattern, 2θ₁, 2θ₂, Δθ₁, 2θ₃, 2θ₄ and Δθ₂ are 18.68°, 18.93°, 0.25°, 44.45°, 45.24° and 0.79°. I₀₀₃/I₁₀₄ of the Li(Ni_{0.5} Co_{0.2}Mn_{0.3})O₂ and the LiCoO₂ are 1.32 and 1.43, respectively. The pressed density of the cathode made of such active substances is 4.0 g/cm³.

In the test for coin cell, the initial reversible capacities of said cathode compounds under the cut-off voltages of 4.3V and 4.4V are 166.3 mAh/g and 178.6 mAh/g, respectively.

If said cathode materials are applied in 454261 polymer batteries, they have a capacity retention rate of 68% after 500 cycles under the voltage of 3.0-4.3V. As to the 85° C./4 h high temperature storage, the cell swelling ratio under the voltage of 4.3V is 160%. As to the 60° C./30d high temperature storage, the cell swelling ratio under the voltage of 4.3V is 52%.

### Comparative Example 3

The active cathode substances used in this comparative example are compound cathode materials, mixed with LiCoO₂ and Li(Ni_{0.5} Co_{0.2}Mn_{0.3})O₂, wherein the LiCoO₂ accounts for 60% by mass, the BET is 0.24 m²/g, the contents of the doped and/or coating elements Mg, Al and Zr are 0.05%, 0.05%, and 0.05%. As shown in the XRD pattern, 2θ₁, 2θ₂, Δθ₁, 2θ₃, 2θ₄ and Δθ₂ are 18.66°, 18.94°, 0.28°, 44.50°, 45.23° and 0.73°. I₀₀₃/I₁₀₄ of the Li(Ni_{0.5} Co_{0.2}Mn_{0.3})O₂ and the LiCoO₂ are 1.27 and 1.42, respectively. The pressed density of the cathode made of such active substances is 4.0 g/cm³.

In the test for coin cell, the initial reversible capacities of said cathode compounds under the cut-off voltages of 4.3V and 4.4V are 156.8 mAh/g and 169.7 mAh/g, respectively.

If said cathode materials are applied in 454261 polymer batteries, they have capacity retention rates of 83% and 79% after 500 cycles under the voltages of 3.0-4.3V and 3.0-4.35V, respectively. As to the 85° C./4 h high temperature storage, the cell swelling ratios under the voltages of 4.3V and 4.35V are 78% and 100%, respectively. As to the 60° C./30d high temperature storage, the cell swelling ratios under the voltages of 4.3V and 4.35V are 5% and 24%, respectively.

In accordance with the foresaid disclosures and teachings, it will be readily apparent to those skilled in the art that a wide variety of alternate embodiments, adaptations or variations of the preferred embodiment(s), and/or equivalent embodiments may be made without departing from the intended scope of the present invention as set forth in the appended claims. The aforementioned embodiments are only explanatory and shall not be used to restrict the implementation and the scope the invention, all changes and modifications made without departing from the invention in its broader aspects are deemed to be within the applied scope of the invention. The terms used herein are intended to illustrate and not to limit the present invention.

What is claimed is:

1. A type of lithium-ion battery cathode materials, wherein:
the cathode materials comprise two active substances of LiCoO₂ and Li(NiₓCo_{y}Mn_{1-x-y}) O₂, where 0.3≦x≦0.8, 0.1≦y≦0.4 and 0.6≦x+y≦0.9;
the LiCoO₂ is doped with element M and then treated by surface coating with the oxide, sulfide or fluoride of element M′ or by phosphate, and the Li(NixCoyMn1-x-y)O₂ is also doped with element M and then treated by surface coating with the oxide, sulfide or fluoride of element M′ or by phosphate, in which the element M is at least one of the Mg, Ti, Al, Zr, B, La, Ce, Y, P, S, N or F while the element M′ is at least one of the Al, Ti, Mg, Zr, B, Si, Fe, La, Ce or Y;
in accordance with the XRD pattern of said cathode materials, the diffraction angle 2θ₁ of the crystal face (003) of the Li(NiₓCo_{y}Mn_{1-x-y})O₂ is 18.55°-18.85° while the diffraction angle 2θ₂ of the crystal face (003) of the LiCoO₂ is 18.85°-19.00°, having the difference Δθ₁ of 0.20°-0.30° therebetween; the diffraction angle 2θ₃ of the crystal face (104) of the Li(NiₓCo_{y}Mn_{1-x-y})O₂ is 44.30°-44.50° while the diffraction angle 2θ₄ of the crystal face (104) of the LiCoO₂ is 45.10°-45.30°, having the difference Δθ₂ of 0.65°-0.85° therebetween;
in accordance with the XRD pattern of said cathode materials, the ratio I₀₀₃/I₁₀₄ between the diffraction peak intensity I₀₀₃ for the crystal face (003) of the Li(NiₓCo_{y}Mn_{1-x-y})O₂ and the diffraction peak intensity I₁₀₄ for the crystal face (104) of the Li(NiₓCo_{y}Mn_{1-x-y})O₂ is 1.10-1.40; the ratio I₀₀₃/I₁₀₄ between the diffraction peak intensity I₀₀₃ for the crystal face (003) of the LiCoO₂ and the diffraction peak intensity I₁₀₄ for the crystal face (104) of the LiCoO₂ is 1.20-1.50;
said cathode materials have a BET of 0.20-0.50 m²/g; and
said cathode materials have a charge cut-off voltage (vs. Li/Li⁺) of 4.2 V-4.6 V.

2. The lithium-ion battery cathode materials according to claim 1, wherein 0.3≦x≦0.5, 0.2≦y≦0.35 and 0.65≦x+y≦0.7 with respect to the Li(NiₓCo_{y}Mn_{1-x-y})O₂.

3. The lithium-ion battery cathode materials according to claim 1, wherein the mass percent of the LiCoO₂ in said cathode materials is 40%-80%.

4. The lithium-ion battery cathode materials according to claim 3, wherein the mass percent of the LiCoO₂ in said cathode materials is 50%-60%.

5. The lithium-ion battery cathode materials according to claim 1, wherein the mass percent of said element M in the whole cathode materials is 0.02-0.6% while the mass percent of the oxide, sulfide, fluoride or phosphate which are coated on said element M′ in the whole cathode materials is 0.05-1%.

6. The lithium-ion battery cathode materials according to claim 1, wherein said 2θ₁ is 18.65°-18.75°, 2θ₂ is 18.90°-18.95° and Δθ₁ is 0.23°-0.27°; said 2θ₃ is 44.40°-44.45°, 2θ₄ is 45.20°-45.25° and Δθ₂ is 0.70°-0.82°.

7. The lithium-ion battery cathode materials according to claim 1, wherein the ratio I₀₀₃/I₁₀₄ between the diffraction peak intensity I₀₀₃ for the crystal face (003) of the Li(NiₓO_{y}Mn_{1-x-y})O₂ and the diffraction peak intensity I₁₀₄ for the crystal face (104) of the Li(NiₓO_{y}Mn_{1-x-y})O₂ is 1.25-1.35; the ratio I₀₀₃/I₁₀₄ between the diffraction peak intensity I₀₀₃ for the crystal face (003) of the LiCoO₂ and the diffraction peak intensity I₁₀₄ for the crystal face (104) of the LiCoO₂ is 1.35-1.45.

8. The lithium-ion battery cathode materials according to claim 1, wherein said cathode materials have the BET of 0.24-0.40 m²/g and the charge cut-off voltage (vs. Li/Li⁺) of 4.3 V-4.5 V.

9. The lithium-ion battery cathode materials according to claim 1, wherein said cathode materials have a pressed density of more than or equal to 3.95 g/cm³, have an initial reversible capacity of more than or equal to 155 mAh/g under 4.3 V cut-off voltage (vs. Li/Li⁺) and have an initial reversible capacity of more than or equal to 170 mAh/g under 4.4 V cut-off voltage (vs. Li/Li⁺).

10. The lithium-ion battery cathode materials according to claim 1, wherein said cathode materials can be treated by secondary coating with the oxide, sulfide or fluoride of the element M″ or with the phosphate, where the element M″ is at least one of the Al, Ti, Mg, Zr, B, Si and Fe.

11. A lithium-ion battery, comprising an anode sheet, a cathode sheet and a separator therebetween as well as an electrolyte, in which said cathode sheet includes a cathode current collector and active cathode substance layers which are coated on said cathode current collector; the cathode substance layers are composed of active cathode substances, adhesives and conductive agent, wherein said active cathode substances are the lithium-ion battery cathode materials as described in claim 1.
